(19) United States
(12) Patent Application Publication
(10) Pub. No.: US 2018/0299316 A1
(43) Pub. Date: Oct. 18, 2018

(54) WATER LEVEL SENSOR

(71) Applicant: ROHM CO., LTD., Kyoto-Shi Kyoto (JP)

(72) Inventors: Hirotoshi USUI, Kyoto-shi Kyoto (JP); Masao NAKAJIMA, Kyoto-shi Kyoto (JP)

(21) Appl. No.: 15/956,064

(22) Filed: Apr. 18, 2018

(30) Foreign Application Priority Data
Apr. 18, 2017 (JP) 2017-082333

(51) Int. Cl. G01F 23/26; E03D 5/10

(52) U.S. Cl. CPC G01F 23/263; E03D 5/105

(57) ABSTRACT

A first electrode is provided to a side wall of a container, and has a width that increases according to an increase in the depth. A second electrode is provided to the side wall of the container, and has a width that reduces according to an increase in the depth. A capacitance sensor measures a first electrostatic capacitance Cs formed by the first electrode and a second electrostatic capacitance Cs formed by the second electrode. A calculation processing unit generates water level data S₂ that represents the water level, based on the measurement values S₁ that represent the respective first and second capacitances Cs.

### CROSS REFERENCE TO RELATED APPLICATIONS

The present application claims priority under 35 U.S.C. § 119 to Japanese Patent Application No. 2017-082333, filed on Apr. 18, 2017, the entire content of which is incorporated herein by reference.

### BACKGROUND OF THE INVENTION

### 1. Field of the Invention

The present invention relates to a technique for measuring the water level.

### 2. Description of the Related Art

As a method for detecting the amount of water, i.e., as a method for detecting the water level, an arrangement employing a float, an optical sensor employing a photosensor, and the like, are known.

### SUMMARY OF THE INVENTION

The present invention has been made in view of such a situation. It is an exemplary purpose of an embodiment of the present invention to provide a water level sensor employing a novel method that differs from conventional techniques.

An embodiment of the present invention relates to a water level sensor structured to measure a water level of a liquid stored in a container. The water level sensor comprises: an electrode provided to a side wall of the container; a capacitance sensor structured to measure an electrostatic capacitance formed by the electrode; and a calculation processing unit structured to generate water level data that represents the water level based on a measurement value of the electrostatic capacitance. The electrostatic capacitance formed by the electrode changes according to the depth at which the electrode is submerged in water. This embodiment allows the water level to be detected based on the electrostatic capacitance.

Another embodiment of the present invention also relates to a water level sensor. The water level sensor comprises: multiple electrodes provided to a side wall of the container at different depths; a capacitance sensor structured to measure an electrostatic capacitance formed by each of the multiple electrodes; and a calculation processing unit structured to generate water level data that represents the water level, based on detection values of the electrostatic capacitances formed by the multiple electrodes. The electrostatic capacitance generated by each electrode exhibits a value that changes depending on whether the electrode is positioned higher than or otherwise lower than the water level. Accordingly, by detecting the number of electrodes that are higher than (or otherwise lower than) the water level from among the multiple electrodes, this arrangement is capable of detecting the water level.

Yet another embodiment of the present invention also relates to a water level sensor. The water level sensor comprises: a first electrode arranged on a side wall of a container, and structured to have a width that increases according to an increase in a depth; a second electrode arranged on the side wall of the container, and structured to have a width that reduces according to an increase in the depth; a capacitance sensor structured to measure a first electrostatic capacitance formed by the first electrode and a second electrostatic capacitance formed by the second electrode; and a calculation processing unit structured to generate water level data that represents the water level, based on measurement values of the first electrostatic capacitance and the second electrostatic capacitance. This embodiment allows the water level to be detected with high precision.

Also, the calculation processing unit may generate the water level data based on a difference between the measurement values of the first electrostatic capacitance and the second electrostatic capacitance.

Also, the calculation processing unit may generate the water level data based on a ratio between the measurement values of the first electrostatic capacitance and the second electrostatic capacitance. Accordingly, an influence of a variation of a dielectric constant of the liquid may be reduced

Also, the sum total of the width of the first electrode and the width of the second electrode may be maintained so as to be approximately constant regardless of the depth. In this case, the depth at which the first electrode and the second electrode have the same width is used as a reference water level. This arrangement is capable of detecting with high precision whether or not the water level is higher or otherwise lower than the reference water level.

Also, the width of the first electrode and the width of the second electrode may each be maintained so as to be constant over a predetermined range in a depth direction. This arrangement is capable of setting a control range (dead band) that corresponds to the aforementioned predetermined range.

Yet another embodiment of the present invention relates to a toilet apparatus. The toilet apparatus may comprise: a toilet; a water tank structured to store flushing water to be supplied to the toilet; a valve arranged on a water discharge path extending from the water tank to the toilet; and a water level sensor.

Also, the water level sensor may detect the water level of the water tank.

Also, when the water level of the water tank decreases to a target water level that corresponds to an amount of flushing water to be supplied to the toilet in flushing, the valve may be closed so as to stop the supply of flushing water from the water tank to the toilet.

Also, the water level sensor may detect the water level of the toilet.

Also, the amount of flushing water supplied from the water tank to the toilet in flushing may be controlled according to the water level of the toilet detected by the water level sensor.

The water level sensor may comprise an electrode provided to a side wall of a water tank, and a capacitance sensor structured to measure an electrostatic capacitance generated by the electrode.

It is to be noted that any arbitrary combination or rearrangement of the above-described structural components and so forth is effective as and encompassed by the present embodiments. Moreover, this summary of the invention does not necessarily describe all necessary features so that the invention may also be a sub-combination of these described features.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a diagram showing a water level sensor according to a first embodiment;

FIGS. 2A through 2D are diagrams each showing a principle of water level measurement performed by the water level sensor shown in FIG. 1;

FIG. 3 is a diagram showing the relation between the water level and the electrostatic capacitance with the water level sensor shown in FIG. 1;

FIG. 4 is a diagram showing a water level sensor according to a second embodiment;

FIG. 5 is a diagram for explaining a principle of water level measurement performed by the water level sensor shown in FIG. 4;

FIG. 6 is a diagram showing a water level sensor according to a third embodiment;

FIG. 7 is a diagram for explaining a principle of water level measurement performed by the water level sensor shown in FIG. 6;

FIG. 8 is a diagram showing the relation between the water level and the electrostatic capacitance with the water level sensor shown in FIG. 6;

FIG. 9 is a diagram showing a modification of a first electrode and a second electrode;

FIG. 10 is a diagram showing a water level sensor according to a fifth embodiment;

FIG. 11 is a diagram showing the relation between the water level and the electrostatic capacitance with the water level sensor shown in FIG. 6; and

FIGS. 12A and 12B are diagrams each showing a toilet apparatus including a water level sensor.

### DETAILED DESCRIPTION OF THE INVENTION

The invention will now be described based on preferred embodiments which do not intend to limit the scope of the present invention but exemplify the invention. All of the features and the combinations thereof described in the embodiment are not necessarily essential to the invention.

Description will be made below regarding the present invention based on preferred embodiments with reference to the drawings. The same or similar components, members, and processes are denoted by the same reference numerals, and redundant description thereof will be omitted as appropriate. The embodiments have been described for exemplary purposes only, and are by no means intended to restrict the present invention. Also, it is not necessarily essential for the present invention that all the features or a combination thereof be provided as described in the embodiments.

In the present specification, the state represented by the phrase “the member A is coupled to the member B” includes a state in which the member A is indirectly coupled to the member B via another member that does not substantially affect the electric connection between them, or that does not damage the functions or effects of the connection between them, in addition to a state in which they are physically and directly coupled.

Similarly, the state represented by the phrase “the member C is provided between the member A and the member B” includes a state in which the member A is indirectly coupled to the member C, or the member B is indirectly coupled to the member C via another member that does not substantially affect the electric connection between them, or that does not damage the functions or effects of the connection between them, in addition to a state in which they are directly coupled.

### First Embodiment

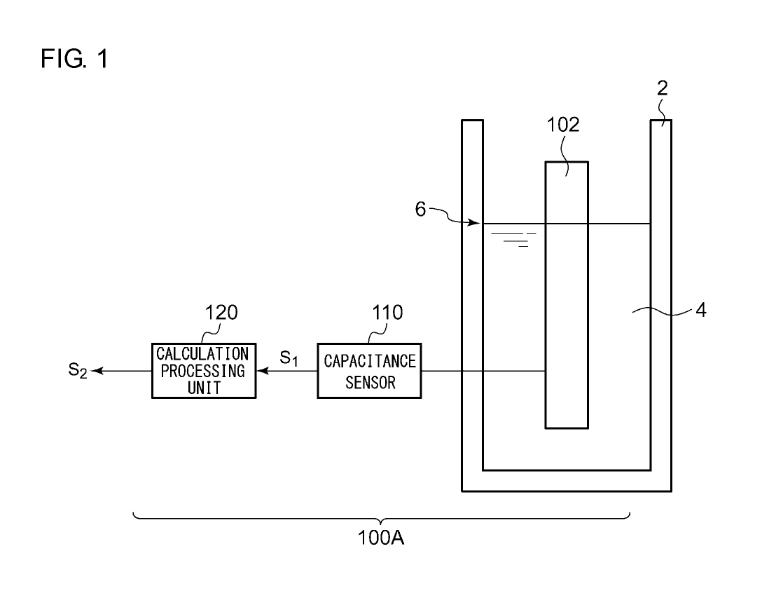

FIG. 1 is a diagram showing a water level sensor according to a first embodiment. A water level sensor 100A shown in FIG. 1 measures the water level 6 of a liquid 4 stored in a container 2. The kind of the liquid 4 is not restricted in particular, but it is, for example, water. The shape of the container 2 is not restricted in particular. The container 2 may have a cylindrical shape. Also, the container 2 may have a quadrangular shape such as a cubic shape, a rectangular shape, or the like. Also, the container 2 may have a desired shape.

The water level sensor 100A includes an electrode 102, a capacitance sensor 110, and a calculation processing unit 120. The electrode 102 is provided to a side wall of the container 2. The electrode 102 may be provided to the inner-side surface of the container 2 such that it is in contact with the liquid 4. Also, the electrode 102 may be provided to the outer-side surface of the container 2. Also, the electrode 102 may be embedded in the side wall of the container 2.

The capacitance sensor 110 measures the electrostatic capacitance Cs formed by the electrode 102. The capacitance sensor 110 measures the electrostatic capacitance Cs using the same principle as that employed in a control circuit (capacitance sensor) for a touch sensor (touch panel) employing an electrostatic capacitance method. The capacitance sensor 110 generates measurement data S₁ that represents the measurement value of the electrostatic capacitance Cs. The capacitance sensor 110 is configured employing known techniques. Accordingly, description thereof will be omitted.

The calculation processing unit 120 receives the measurement data S₁ from the capacitance sensor 110. The calculation processing unit 120 generates water level data S₂ that represents the water level 6, based on the measurement value of the electrostatic capacitance Cs. The calculation processing unit 120 may be configured as a hardware component such as an ASIC (Application Specified IC), FPGA (Field Programmable Gate Array), or the like. Also, the calculation processing unit 120 may be configured as a combination of a general-purpose processing circuit such as a microcomputer, CPU (Central Processing Unit), or the like, and a software program. The capacitance sensor 110 and the calculation processing unit 120 may be integrated in the form of a single IC.

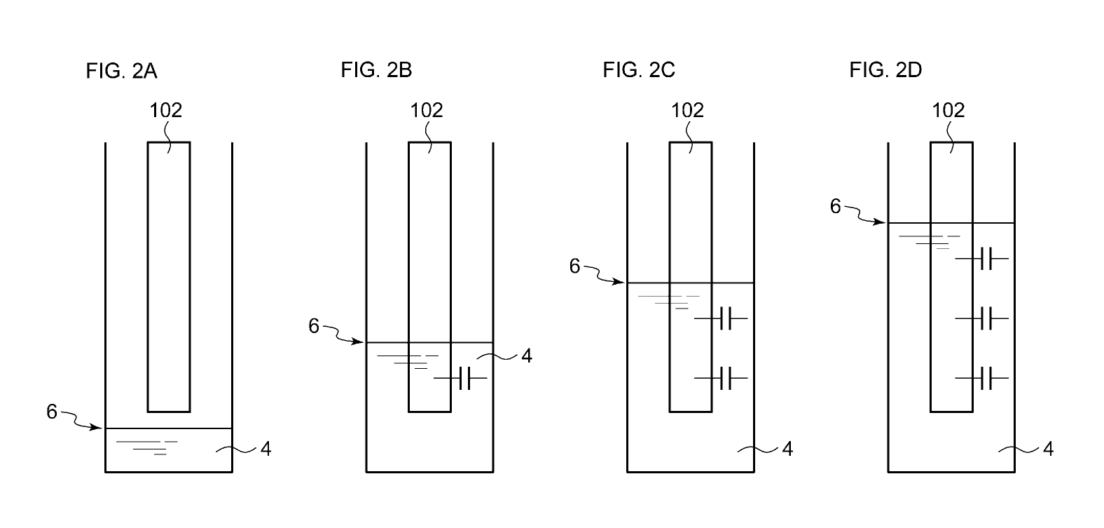

The above is the configuration of the water level sensor 100A. Next, description will be made regarding the operation principle thereof. FIGS. 2A through 2D are diagrams each showing the water level measurement principle employed in the water level sensor 100A shown in FIG. 1. The water level 6 is different in each of FIGS. 2A through 2D. When air surrounds the electrode 102, the electrostatic capacitance formed by the electrode 102 is small. As the water level 6 becomes higher as shown in FIGS. 2B, 2C, and 2D, the portion of the electrode 102 submerged in the liquid 4 becomes larger, which raises the electrostatic capacitance Cs formed by the electrode 102. FIGS. 2B through 2C each show the water level sensor 100A as a lumped constant circuit represented by a combination of one to three capacitors each having a given electrostatic capacitance. In actuality, the water level sensor 100A can be represented by a distributed constant circuit.

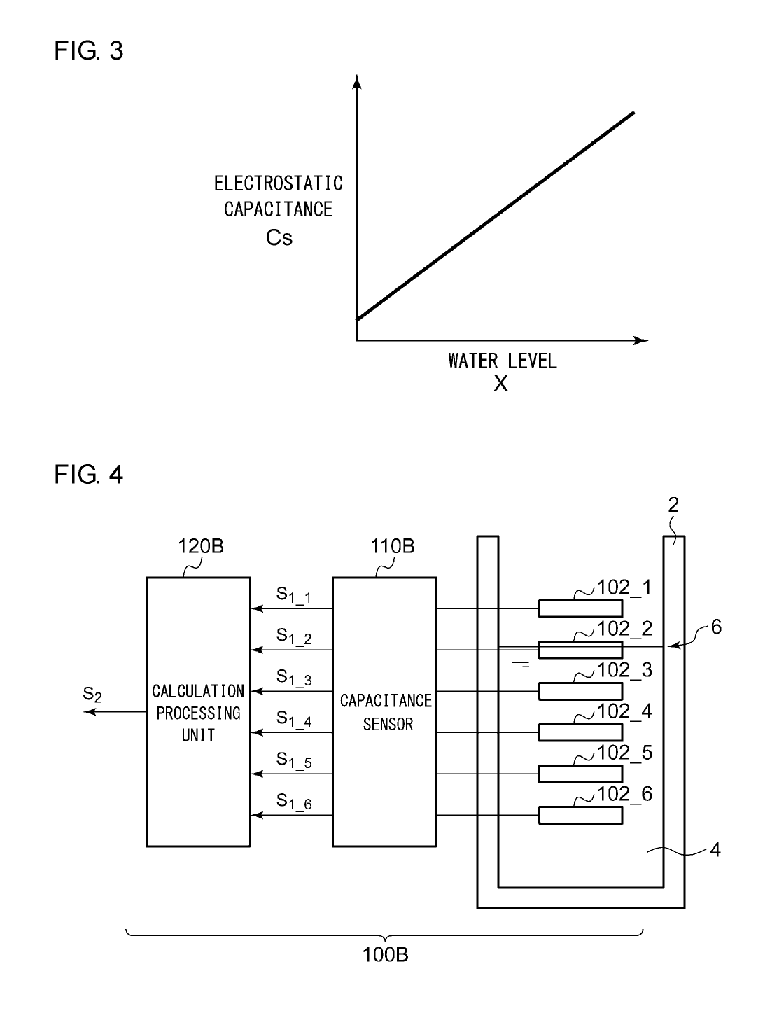

FIG. 3 is a diagram showing a relation between the water level and the electrostatic capacitance Cs with the water level sensor 100A shown in FIG. 1. The electrostatic capacitance Cs rises linearly according to an increase in the water level 6. There is a one-to-one correspondence between the electrostatic capacitance Cs and the water level. Thus, the water level sensor 100A is capable of measuring the water level 6 based on the electrostatic capacitance.

### Second Embodiment

The water level sensor 100A according to the first embodiment shown in FIG. 1 is capable of measuring the water level 6 with high precision in a case in which the liquid 4 has a constant dielectric constant. However, in a case in which the liquid 4 has a variable dielectric constant, the measurement error with the water level sensor 100A becomes large. In particular, water has a dielectric constant that heavily depends on the temperature. The second embodiment is configured to solve this problem.

FIG. 4 is a diagram showing a water level sensor 100B according to a second embodiment. The water level sensor 100B includes multiple, i.e., N (N≥2), electrodes 102_1 through 102_N, a capacitance sensor 110B, and a calculation processing unit 120B. FIG. 4 shows an example in which N=6. The multiple electrodes 102_1 through 102_N are provided to the side wall of the container 2 at different depths.

The capacitance sensor 110B measures the electrostatic capacitances Cs₁ through Cs_{N} formed by the respective multiple electrodes 102_1 through 102_N, and generates measurement data S₁_{_}₁ through S₁_{_}_{N} that represent the respective measurement values. The calculation processing unit 120B receives the measurement data S₁_{_}₁ through S₁_{_}_{N}, and generates water level data S₂ that that represents the water level 6.

The calculation processing unit 120B may judge whether or not each measurement data S₁_{_}ᵢ; (1≤i≤N) is larger than a predetermined value, i.e., whether or not each electrostatic value Csᵢ is larger than a threshold value TH, and may generate intermediate data S₃_{_}ᵢ. For example, when the electrostatic capacitance Csᵢ represented by S₁_{_}ᵢ is lower than the threshold value TH, the intermediate data S₃_{_}ᵢ is set to 0. Conversely, when the electrostatic capacitance Csᵢ is larger than the threshold value TH, the intermediate data S₃_{_}ᵢ is set to 1. The calculation processing unit 120B may generate the water level data S₂ that represents the water level 6 based on the multiple intermediate data S₃_{_}₁ through S₃_{_}_{N}.

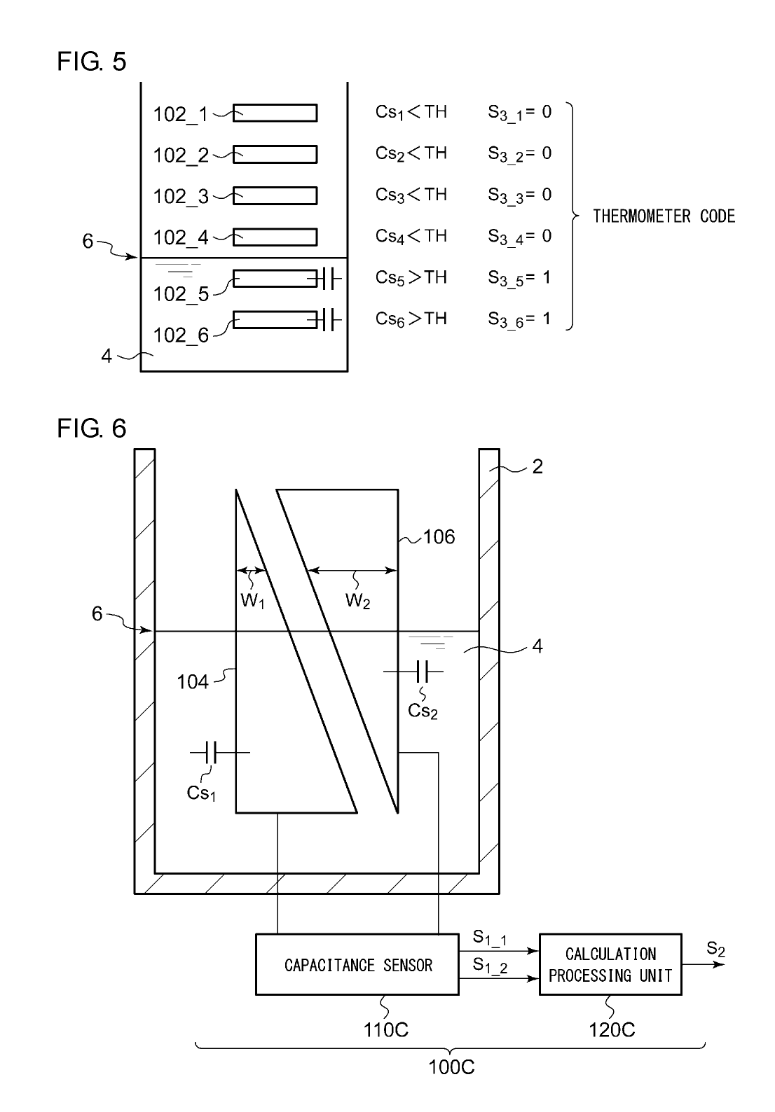

FIG. 5 is a diagram for explaining the principle of the water level sensor 100B shown in FIG. 4 for measuring the water level.

Judgement that the electrostatic capacitance Csᵢ formed at a given electrode 102_i means that a part or otherwise the whole of the electrode 102_i has been submerged in the liquid 4. In the example shown in FIG. 5, the first electrode 102_1 through the fourth electrode 102_4 are each higher than the water level 6. Accordingly, the electrostatic capacitances Cs₁ through Cs₄ formed by these electrodes are each smaller than the threshold value TH. The remaining electrodes, i.e., the fifth electrode 102_5 and the sixth electrode 102_6 are each lower than the water level 6. Accordingly, the electrostatic capacitances Cs₅ and Cs₆ formed by these electrodes are each larger than the threshold value TH.

That is to say, the intermediate data S₃_{_}₁ through S₃_{_}_{N} are configured as a thermometer code that represents the water level 6. The thermometer code may be employed as the water level data S₂. Also, the thermometer code may be converted into binary data, and the binary data thus converted may be employed as the water level data S₂.

The water level sensor 100B does not require each of the electrodes 102_1 through 102_N to have a resolution in the depth direction. Thus, this arrangement is capable of measuring the water level 6 with high precision even if the dielectric constant of the liquid 4 varies.

### Third Embodiment

FIG. 6 is a diagram showing a water level sensor 100C according to a third embodiment. The water level sensor 100C includes a first electrode 104, a second electrode 106, a capacitance sensor 110C, and a calculation processing unit 120C.

The first electrode 104 is provided to the side wall of the container 2. The first electrode 104 is configured to have a width W₁ that increases according to an increase in the depth. In this example, the first electrode 104 is configured to have a tapered triangular shape. However, the shape of the first electrode 104 is not restricted in particular. The first electrode 104 may have a trapezoidal shape.

The second electrode 106 is provided to the side wall of the container 2. The second electrode 106 is configured to have a width W₂ that reduces according to an increase in the depth. The first electrode 104 and the second electrode 106 are arranged at substantially the same depth. In the example shown in FIG. 6, the sum total of the width W₁ of the first electrode 104 and the width W₂ of the second electrode 106 are approximately constant regardless of the depth.

The capacitance sensor 110C measures the first electrostatic capacitance Cs₁ formed by the first electrode 104 and the second electrostatic capacitance Cs₂ formed by the second electrode 106. Furthermore, the capacitance sensor 110C generates the measurement data S₁_{_}₁ and S₁_{_}₂ that represent the respective measurement values. The calculation processing unit 120C generates the water level data S₂ that represents the water level 6 based on the measurement data S₁_{_}₁ and S₁_{_}₂ respectively representing the first electrostatic capacitance Cs₁ and the second electrostatic capacitance Cs₂.

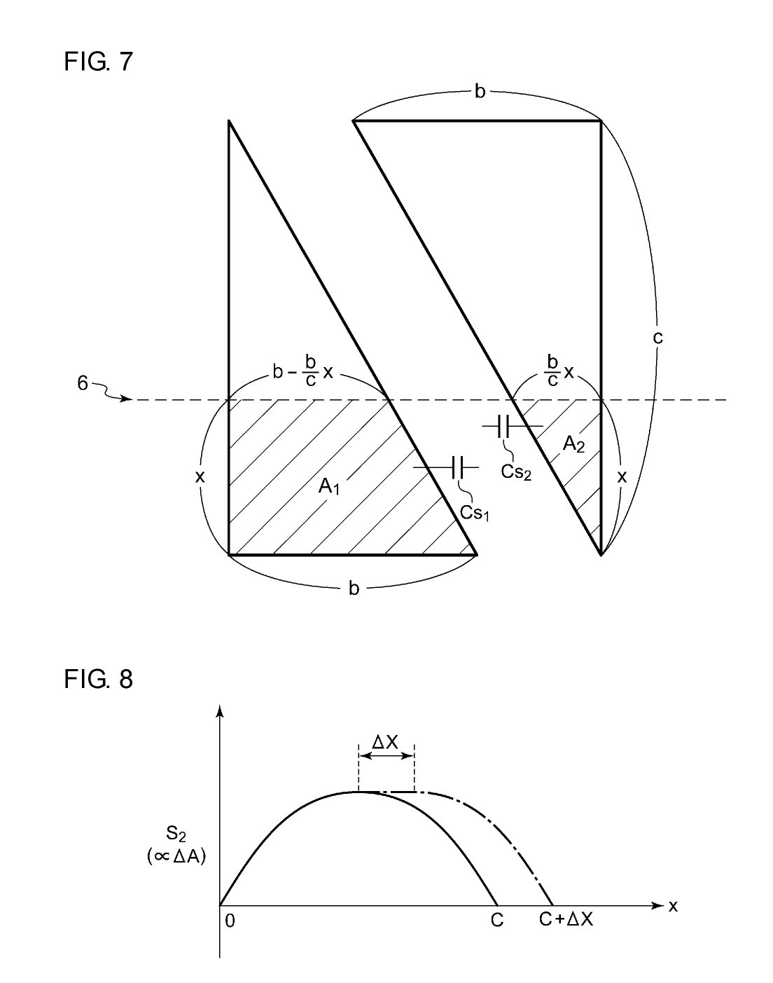

The above is the configuration of the water level sensor 100C. FIG. 7 is a diagram for explaining the principle of the water level measurement performed by the water level sensor 100C shown in FIG. 6. In a case in which the liquid 4 has a dielectric constant that is sufficiently larger than that of air, the electrostatic capacitance at a position that is higher than the water level 6 can be ignored. In this case, the electrostatic capacitances Cs₁ and Cs₂ are each proportional to the area submerged in the liquid 4, i.e., are respectively proportional to the areas A₁ and A₂. With the sum total of W₁ and W₂ as b, with the height of each of the electrodes 104 and 106 as c, and with the length of the portion of each electrode that is lower than the water level 6 in the depth direction as x, the areas A₁ and A₂ are represented by the following Expressions.

A₁=(2b−b x/c)×x/2=−b/2×x²+bx

A₂=bx/c×x/2=b/2c×x²

The calculation processing unit 120C generates the water level data S₂ based on the difference between the measurement data S₁_{_}₁ that represents the first electrostatic capacitance Cs₁ and the measurement data S₁_{_}₂ that represents the second electrostatic capacitance Cs₂, i.e., based on ΔS=S₁_{_}₁−S₁_{_}₂.

FIG. 8 is a diagram showing the relation between the water level and the water level data S₂ with the water level sensor shown in FIG. 6. The difference in the electrostatic capacitance is represented by a quadratic function that is convex upward. The difference in the electrostatic capacitance exhibits a maximum value when x matches half the height c of the two electrodes 104 and 106. Furthermore, when x=0 or otherwise x=c, the electrostatic capacitance becomes zero.

The advantage of the water level sensor 100C can be clearly understood in comparison with the water level sensor 100A shown in FIG. 1. As described above, the water level sensor 100A shown in FIG. 1 is affected by the dielectric constant. In contrast, with the water level sensor 100C shown in FIG. 6, when the difference in electrostatic capacitance exhibits a non-zero value, this ensures that the water level is positioned in a range of the height of the two electrodes. Furthermore, such an arrangement ensures that, when x matches half the height c, the electrostatic capacitance exhibits its maximum value. Accordingly, in a case in which the dielectric constant varies, the water level sensor 100C is capable of detecting the water level with higher precision than that of the water level sensor 100A shown in FIG. 1.

### Fourth Embodiment

A water level sensor 100D according to a fourth embodiment has the same configuration as that of the water level sensor 100C shown in FIG. 6. There is a difference in the operation of the calculation processing unit 120C between the water level sensors 100D and 100C. Specifically, in the fourth embodiment, the calculation processing unit 120C generates the water level data S₂ that represents the water level based on the ratio between the two measurement data S₁_{_}₁ and S₁_{_}₂. The ratio between the two measurement data S₁_{_}₁ and S₁_{_}₂ has a one-to-one correspondence with the water level. Accordingly, the relation expression that represents the relation between the ratio and the water level may preferably be calculated or otherwise measured in actuality. The calculation processing unit 120C may perform calculation or otherwise table reference processing with the ratio as its input and with the water level as its output. By employing the ratio, the effect of the dielectric constant is canceled out, thereby allowing the water level to be detected with high precision.

### Modification of the Third and Fourth Embodiments

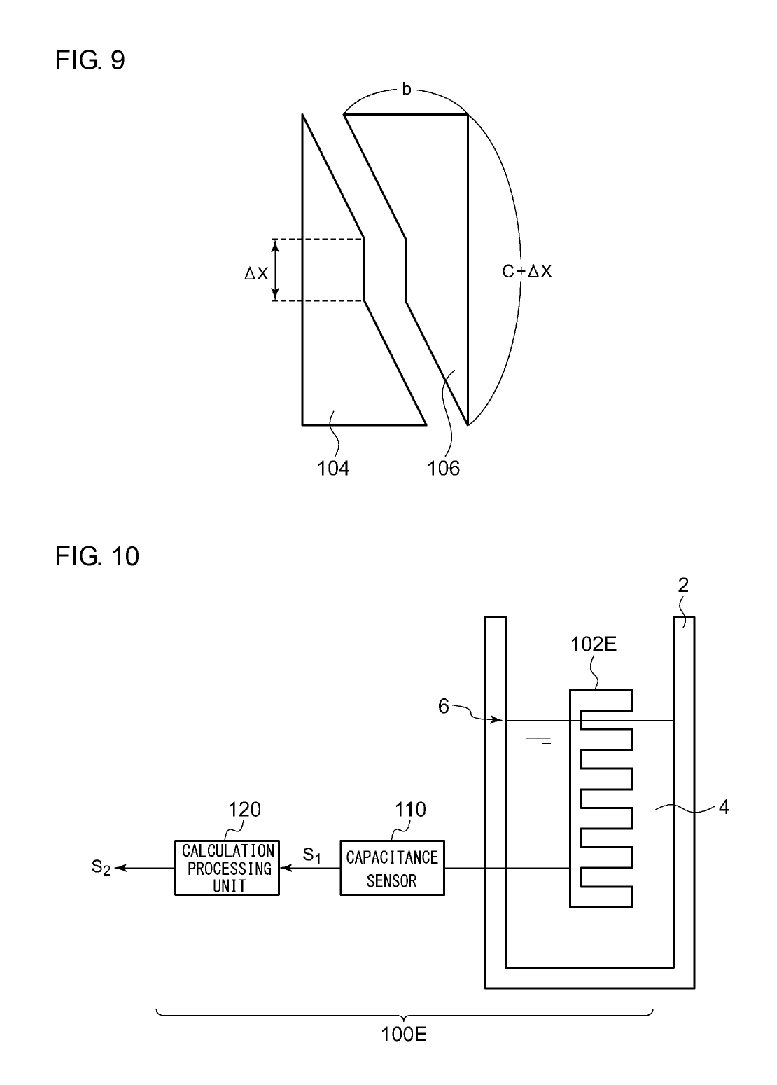

FIG. 9 is a diagram showing a modification of the first electrode 104 and the second electrode 106. In this modification, the first electrode 104 and the second electrode 106 have the same width that is constant over a predetermined range ΔX in the depth direction. By employing such an electrode structure, this arrangement is capable of providing a dead band in which the electrostatic capacitances respectively formed by the two electrodes do not change according to a change in the depth. For example, in a case in which the predetermined range ΔX is provided at a position at which W₁=W₂=b/2, this arrangement allows the water level data S₂ to have its maximum value in the form of a flat line as indicated by the dashed line shown in FIG. 8.

### Fifth Embodiment

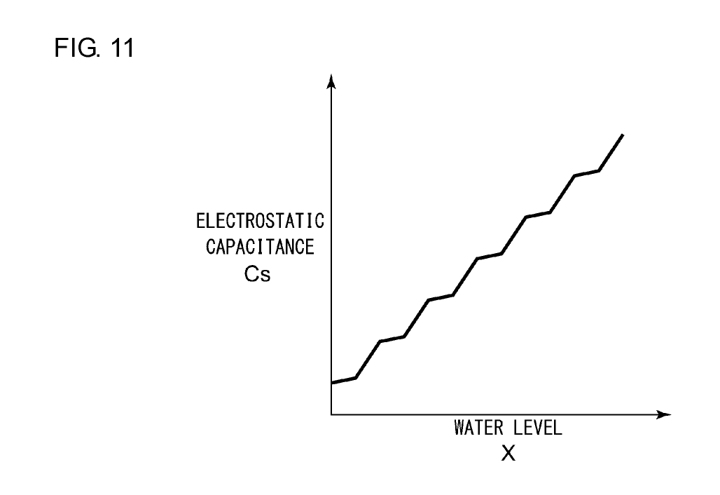

FIG. 10 is a diagram showing a water level sensor 100E according to a fifth embodiment. The water level sensor 100E includes a comb-shaped electrode 102E. FIG. 11 is a diagram showing the relation between the water level and the capacitance formed by the electrode with the water level sensor shown in FIG. 10. When the water level is positioned in a region of a recessed portion of the comb-shaped electrode, the electrostatic capacitance Cs slowly rises according to an increase in the water level. When the water level is positioned in a region of a protruding portion of the comb-shaped electrode, the electrostatic capacitance Cs rapidly rises according to an increase in the water level. With the water level sensor 100E, the water level can be detected with high precision.

### Application/Usage

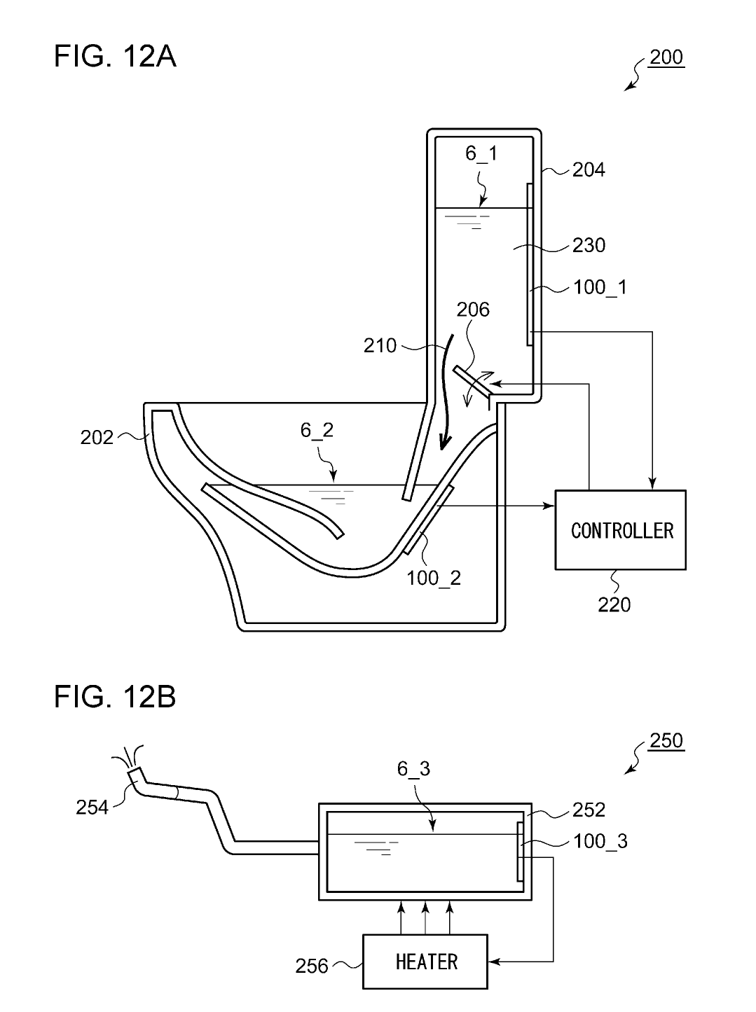

Next, description will be made regarding a usage of the water level sensors 100A through 100D (which will collectively be referred to as the “water level sensor 100” hereafter). Examples of a preferable usage of the water level sensor 100 includes a toilet apparatus. FIGS. 12A and 12B are diagrams each showing a toilet apparatus 200 including the water level sensor 100.

As shown in FIG. 12A, the toilet apparatus 200 includes a toilet 202, a water tank (tank) 204, and a valve 206. The water tank 204 stores flushing water 230 to be supplied to the toilet 202. The valve 206 is provided on a water discharge path 210 extending from the water tank 204 to the toilet 202.

The toilet apparatus 200 is provided with the water level sensors 100_1 and 100_2. For simplicity, FIG. 12 shows only the electrode of the water level sensor 100. The water level sensor 100 may be configured employing as any one of the aforementioned embodiments. The water level sensor 100_1 detects a water level 6_1 of the water tank 204. The water level sensor 100_2 detects a water level 6_2 of the toilet 202.

The toilet apparatus 200 includes a controller 220. The controller 220 is coupled to the water level sensors 100_1 and 100_2, thereby allowing the water level of the water tank 204 and the water level of the toilet 202 to be detected.

At the same time as the start of flushing, the controller 220 opens the valve 206. Subsequently, the controller 220 monitors the output of the water level sensor 100_1. When the water level 6 of the water tank 204 decreases to a target water level REF that corresponds to the amount of flushing water to be supplied to the toilet 202 in the flushing step, the controller 220 closes the valve 206 so as to stop the supply of flushing water from the water tank 204 to the toilet 202. The amount of flushing water to be supplied is variable. Accordingly, the target water level REF is designed to be variable. The amount of flushing water to be supplied may be specified by the user. Also, as described later, the controller 220 may automatically determine the amount of flushing water.

The controller 220 determines the amount of flushing water to be supplied to the toilet 202 at the time of flushing, according to the water level 6_2 of the toilet 202 detected by the water level sensor 100_2. That is to say, in a case in which a great rise occurs in the water level when the toilet is used, the amount of flushing water to be supplied is raised. Conversely, in a case in which a small rise occurs in the water level when the toilet is used, the amount of flushing water to be supplied is lowered.

The above is the configuration of the toilet apparatus 200. The toilet apparatus 200 is capable of controlling the amount of flushing water with high precision, thereby allowing water saving. With conventional techniques, multiple flushing modes are prepared, examples of which include a large (full) flushing mode, a small (half) flushing mode, and an eco flushing mode. In this case, the user selects an appropriate flushing mode. With the toilet apparatus 200, the controller 220 is capable of automatically determining the amount of flushing water. Furthermore, this arrangement is capable of continuously controlling the amount of flushing water according to the rise of the water level when the toilet is used. This provides improved flushing performance while maintaining a balance between the flushing performance and water saving.

Description will be made with reference to FIG. 12B. In some cases, the toilet apparatus 200 includes an electronic bidet 250. FIG. 12B shows the electronic bidet 250 according to an embodiment. The electronic bidet 250 includes a water tank 252, a washing nozzle 254, and a heater 256. The heater 256 applies heat to water stored in the water tank 252. The water tank 252 is provided with a water level sensor 100_3 that detects a water level 6_3. The output of the water level sensor 100_3 may be used to control the amount of water supplied to the water tank 252. This arrangement is capable of preventing overflow of the water stored in the water tank 252. Also, the heater 256 may control the degree of heat application according to the output of the water level sensor 100_3. For example, when the water level 6_3 is lower than a predetermined reference water level, the heater 256 may stop the application of heat. This provides so-called empty heating protection.

While the preferred embodiments of the present invention have been described using specific terms, such description is for illustrative purposes only, and it is to be understood that changes and variations may be made without departing from the spirit or scope of the appended claims.

What is claimed is:

1. A water level sensor structured to measure a water level of a liquid stored in a container, the water level sensor comprising:
a first electrode arranged on a side wall of the container, and structured to have a width that increases according to an increase in a depth;
a second electrode arranged on the side wall of the container, and structured to have a width that reduces according to an increase in the depth;
a capacitance sensor structured to measure a first electrostatic capacitance formed by the first electrode and a second electrostatic capacitance formed by the second electrode; and
a calculation processing unit structured to generate water level data that represents the water level, based on measurement values that respectively represent the first electrostatic capacitance and the second electrostatic capacitance.

2. The water level sensor according to claim 1, wherein the calculation processing unit generates the water level data based on a difference between the measurement values of the first electrostatic capacitance and the second electrostatic capacitance.

3. The water level sensor according to claim 1, wherein the calculation processing unit generates the water level data based on a ratio between the measurement values of the first electrostatic capacitance and the second electrostatic capacitance.

4. The water level sensor according to claim 1, wherein a sum total of the width of the first electrode and the width of the second electrode is maintained so as to be approximately constant regardless of the depth.

5. The water level sensor according to claim 1, wherein the width of the first electrode and the width of the second electrode are each maintained so as to be constant over a predetermined range in a depth direction.

6. A water level sensor structured to measure a water level of a liquid stored in a container, the water level sensor comprising:
a plurality of electrodes provided to a side wall of the container at different depths;
a capacitance sensor structured to measure an electrostatic capacitance formed by each of the plurality of electrodes; and
a calculation processing unit structured to generate water level data that represents the water level, based on detection values of the electrostatic capacitances formed by the plurality of electrodes.

7. A water level sensor structured to measure a water level of a liquid stored in a container, the water level sensor comprising:
an electrode provided to a side wall of the container;
a capacitance sensor structured to measure an electrostatic capacitance formed by the electrode; and
a calculation processing unit structured to generate water level data that represents the water level based on a measurement value of the electrostatic capacitance.

8. A toilet apparatus comprising:
a toilet;
a water tank structured to store flushing water to be supplied to the toilet;
a valve arranged on a water discharge path extending from the water tank to the toilet; and
the water level sensor according to claim 1.

9. The toilet apparatus according to claim 8, wherein the water level sensor detects a water level of the water tank.

10. The toilet apparatus according to claim 9, wherein, when the water level of the water tank decreases to a target water level that corresponds to an amount of flushing water to be supplied to the toilet in flushing, the valve is closed so as to stop the supply of flushing water from the water tank to the toilet.

11. The toilet apparatus according to claim 8, wherein the water level sensor detects the water level of the toilet.

12. The toilet apparatus according to claim 11, wherein an amount of flushing water supplied from the water tank to the toilet in flushing is controlled according to the water level of the toilet detected by the water level sensor.

13. A toilet apparatus comprising:
a toilet;
a water tank structured to store flushing water to be supplied to the toilet;
a valve arranged between the water tank and the toilet; and
a water level sensor structured to detect a water level of the water tank,
wherein the water level sensor comprises:
an electrode provided to a side wall of the container; and
a capacitance sensor structured to measure an electrostatic capacitance formed by the electrode.
